(19) United States
(12) Patent Application Publication
(10) Pub. No.: US 2015/0143859 A1
(43) Pub. Date: May 28, 2015

(54) TIRE AND WHEEL THEFT PREVENTION DEVICE AND METHODS

(71) Applicant: James F. Beck, JR., Shavano Park, TX (US)

(72) Inventor: James F. Beck, JR., Shavano Park, TX (US)

(21) Appl. No.: 14/088,629

(22) Filed: Nov. 25, 2013

(51) Int. Cl. B60R 25/01; F16B 41/00

(52) U.S. Cl. CPC B60R 25/01; F16B 41/005
USPC 70/431

(57) ABSTRACT

Tire theft prevention device and methods. At least some of example embodiments include a tire removal prevention device comprising: an elongate member having a first end and a second end, the first and second ends defining an elongate axis; a collar member coupled to the elongate member, the collar defining an interior cavity, a first aperture, and a second aperture opposite the first aperture, the second aperture having an area smaller than the first aperture; and a riser member coupled to the elongate member, the riser defining a third aperture having an area larger than the second aperture.

### BACKGROUND

Tire and wheel theft prevention devices are used to prevent unauthorized removal or theft of automobile wheels and tires. These devices may prevent removal of tire lug nuts without a proper key or tool thus making removal of an automobile wheel more difficult and offering some level of protection against theft of a wheel and/or tire. Some existing systems can be compromised by a bad actor determined to steal a wheel and/or the tire mounted on the wheel. As one example, locking lug nuts which are designed to be removable only using a specialized key or tool may be compromised by cutting, hammering, or by use of tools designed to grip and turn locking nuts by application of external torque without the key. Also, locking lug nuts do not prevent theft of tires by deflation and unmounting of the tire from the wheel. For at least these reasons, any advancement which provide better protection against tire and/or wheel theft would be advantageous.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 shows a perspective view of a wheel and tire theft prevention device in accordance with at least some embodiments mounted on a front wheel of a heavy duty truck;

FIG. 2 shows a perspective view of a wheel and tire theft prevention device in accordance with at least some embodiments;

FIG. 3 shows a cross-section al elevation view of a wheel and tire theft prevention device mounted on a vehicle wheel in accordance with at least some embodiments;

FIG. 4 shows a perspective view of a wheel and tire theft prevention device mounted on the rear wheel of a heavy duty truck in accordance with at least some embodiments;

FIG. 5 shows a perspective view of a wheel and tire theft prevention device in accordance with at least some embodiments;

FIG. 6 shows cross-sectional elevation view of a lug extension mounted on a vehicle wheel in accordance with at least some embodiments;

FIG. 7 shows cross-sectional elevation view of a wheel and tire theft prevention device mounted on a vehicle wheel in accordance with at least some embodiments; and

FIG. 8 shows a flow chart of a method in accordance with at least some embodiments.

### NOTATION AND NOMENCLATURE

Certain terms are used throughout the following description and claims to refer to particular system components. As one skilled in the art will appreciate, different companies may refer to a component by different names. This document does not intend to distinguish between components that differ in name but not function.

In the following discussion and in the claims, the terms “including” and “comprising” are used in an open-ended fashion, and thus should be interpreted to mean “including, but not limited to . . . .” Also, the term “couple” or “couples” is intended to mean either an indirect or direct connection. Thus, if a first device couples to a second device, that connection may be through a direct connection or through an indirect connection via other devices and connections.

“Wheel” shall mean a vehicle wheel on which a vehicle tire may be mounted.

“Tire” shall mean a vehicle tire, mountable on a vehicle wheel.

“Inflexible” shall mean that a device cannot be deflected more than two inches by human force applied directly to the device, or by human force applied to the device using a mechanical lever shorter than four feet in length. For purposes of defining “inflexible”, deflection shall be measured at a distal tip of the device, and the deflection shall be measured relative to a rest orientation of the device.

“Locking” shall mean coupling using a mechanism configured to prevent decoupling without the use of a tool keyed to the mechanism.

“About” shall mean within plus or minus five percent (+/−5%) of a recited value

### DETAILED DESCRIPTION

The following discussion is directed to various embodiments of the invention. Although one or more of these embodiments may be preferred, the embodiments disclosed should not be interpreted, or otherwise used, as limiting the scope of the disclosure or the claims. In addition, one skilled in the art will understand that the following description has broad application, and the discussion of any embodiment is meant only to be exemplary of that embodiment, and not intended to intimate that the scope of the disclosure or the claims, is limited to that embodiment.

Various embodiments are directed to tire and wheel theft prevention devices that reduce the chances of theft of a wheel and tire, or set of wheels and tires, on which the devices are installed. More particularly, various embodiments are directed to devices and systems that may be installed on vehicle wheels (e.g., truck wheels) to prevent theft of tires and wheels, for example when the vehicles are parked in sales lots or in storage. Even more particularly, various embodiments are directed to devices providing protection against tire and wheel theft while not compromising the ability of a vehicle to be driven with the device installed on one or more wheels. Various embodiments are directed to devices for protection of large and typically expensive heavy industrial tires from theft. Additional embodiments are directed to methods for protecting tires and wheels from theft. The specification first turns to two exemplary embodiments, then discusses methods for preventing theft.

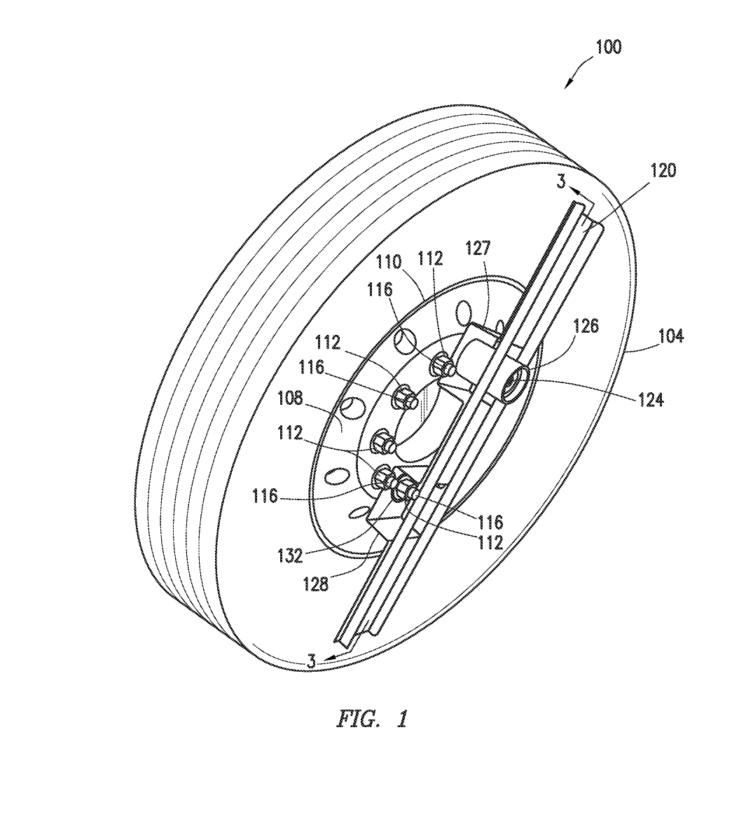

FIG. 1 shows a perspective view of an example wheel and tire assembly 100 in accordance with at least some embodiments. Tire 104 is mounted on wheel 108 which is coupled to the axle of a vehicle (not pictured) by a set of lug nuts 112 configured to fit on lug bolts 116. A theft prevention device 120 is mounted on the wheel 108 and extends across the wheel from one side of the tire's rim 110 to another side and further extends across portions of the tire 104 on two sides of the rim. The theft prevention device 120 is locked to the wheel by a lock 124 coupled to one of the lug bolts 116. The lock 124 is surrounded by a protective collar 126 which guards the lock against unauthorized removal (e.g., by rotation of the locking device without a key or key socket). The collar may be coupled to the theft prevention device 120 by a first riser 127 to position the theft prevention device 120 so as not to contact the tire 104. The theft prevention device 120 is also coupled to the wheel at a second location by a second riser 128. In the embodiment depicted in FIG. 1, the second riser 128 rests against the wheel in an area adjacent to and surrounding one of the lug nuts 112. In some embodiments the second riser 128 may be secured against the wheel 108 by one of the lug nuts 112, or the second riser 128 may comprise a circular cutout area 132 sized to fit around the perimeter of a lug nut 112. The second riser 128 provides a second point or area of contact for the theft prevention device 120, holding the device away from the surface of the tire 104. Riser 128 and may also prevent rotation of the theft prevention device 120 relative to the wheel 108, thus keeping the theft prevention device in position to prevent tire removal. The length of the theft prevention device 120 may be selected so that the theft prevention device extends far enough past the rim 110 of the wheel 108 that it becomes difficult to remove the tire from the wheel with the theft prevention device 120 locked to the wheel, but short enough that the ends of the theft prevention device 120 will not contact the ground when the tire 104 is compressed during movement of the vehicle.

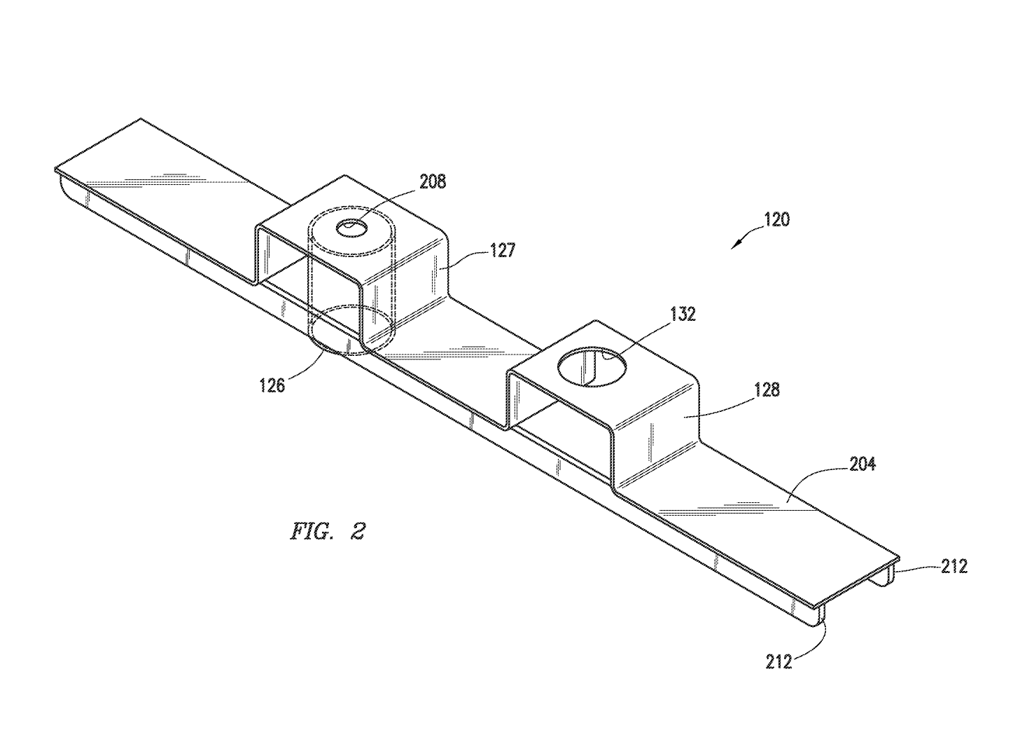

FIG. 2 shows a perspective view of the theft prevention device 120 of FIG. 1. In some embodiments, the device may be comprised of an elongate strip of steel 204 extending the length of the device. The strip 204 may comprise a series of bends forming risers 127 and 128. In other embodiments, the device may be comprised of channel iron and risers 127 and 128 could be welded in place. Riser 128 comprises a cutout area 132 to accommodate placement of the theft prevention device 120 with riser 128 resting against a wheel on the area surrounding one of the lug nuts 112. Riser 127 comprises a cutout area 208 to accommodate a lug bolt 116 disposed through the cutout area and extending into the interior area defined by the collar 126. The theft prevention device 120 may also comprise stiffening ribs 212 welded to the strip 204 to add rigidity to the theft prevention device 120, and to prevent flexing of the theft prevention device along the theft prevention device's length. In embodiments where the device is comprised of channel iron rather than of a strip of steel, the sides of the channel iron would serve as integral ribs.

In some example embodiments, the strip 204 may be a four-inch-wide strip of 10 gauge steel, and the stiffening ribs 212 may each be ¼ inch thick, one-inch-wide ribs welded to the strip 204 and extending the entire length of the theft prevention device 120. Collar 126 may be a 2% inch Schedule 10 steel pipe 4 inches long. In some embodiments, the tire theft prevention device may be 35% inches in length and risers 127, 128 may extend 2% inches away from the portions of the strip 204 coupled to the stiffening ribs 112. In some embodiments, cutout area 132 may have a diameter of 2¼ inches and cutout area 208 may have a diameter of one inch. The centers of cutouts 132, 208 may be separated by a distance of 11¼ inches. The measurements above are given by way of example only. In various embodiments the dimensions and configuration given above may be altered depending on the particular application. For example, the dimensions of the theft prevention device may depend on various factors including: the bolt pattern of the wheel on which the device will be used; the diameters of lug bolts used to couple the wheel to the vehicle; the size of lug nuts for a particular wheel; the profile of the vehicle tire the device is to be used with; or on the particular locking device to be used with the device. Furthermore, the various components discussed above may take any of a multitude of forms depending on various factors. As one example, the theft prevention device may be constructed out of an I-beam, channel iron, or other structural beam rather than out of sheet steel as discussed above. The theft prevention device may also be constructed out of any suitable material in addition to those materials discussed above.

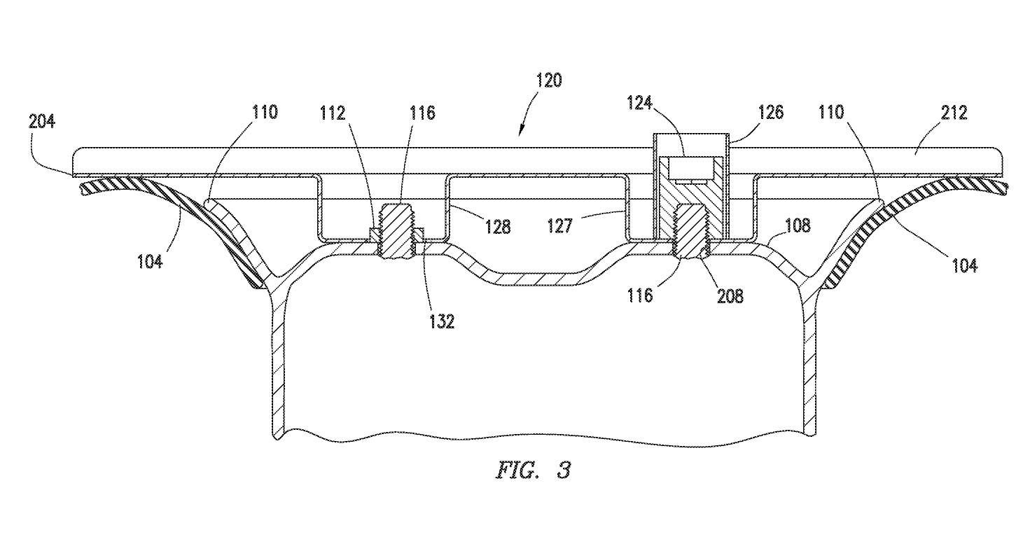

FIG. 3 is a cross-sectional view of theft prevention device 120 taken along the line 3-3 of FIG. 3. In the cross-sectional view of FIG. 3, the theft prevention device 120 is shown locked to a wheel 108 with a mounted tire 104. The wheel 108 and tire 104 of FIG. 1 are also depicted in the cross-section for purposes of illustration. As can be seen in the example embodiment of FIG. 3, the theft prevention device is coupled to the wheel by locking device 124 which is surrounded by collar 126. The collar 126 protects the locking device 124 from being removed (e.g., by application of torque to the exterior diameter of the locking device) without a key or key socket. The theft prevention device is held away from the tire 104 by risers 127, 128. The riser 127 is coupled to the collar 126, and comprises cutout area 208 through which a lug bolt 116 extends. Locking device 124 is coupled to the lug bolt 116 extending through cutout area 208. Riser 128 comprises a cutout area 132 configured to fit around a lug bolt 112. Riser 128 acts as a second point of support for the theft prevention device 120, and also prevents rotation of the theft prevention device 120 relative to the wheel 108. In some embodiments, stiffening ribs 212 may be coupled to the theft prevention device 120 to make the theft prevention device 120 inflexible about the theft prevention device's elongate axis so as to prevent cutout area 132 from being forced away from the wheel 108 and over the lug nut 112 and lug bolt 116 the cutout area 132 surrounds.

In the example embodiment of FIG. 3, even if tire 104 is deflated or even partially un-mounted from wheel 108, the tire 104 cannot be completely removed from the wheel 108 with the locking device 120 in place. Furthermore, compromise of the locking device 124 is made more difficult by the locking device 124 being surrounded by a collar 126. The collar both protects the locking device from being removed (e.g., by application of external torque), and helps protect the locking device against compromise by sawing or cutting. Furthermore, if the length of the theft prevention device 120 is selected so as to not project beyond the diameter of the tire 104 when compressed by the weight of a vehicle, the theft prevention device 120 need not be removed from a wheel in order to move a vehicle, especially at low speeds.

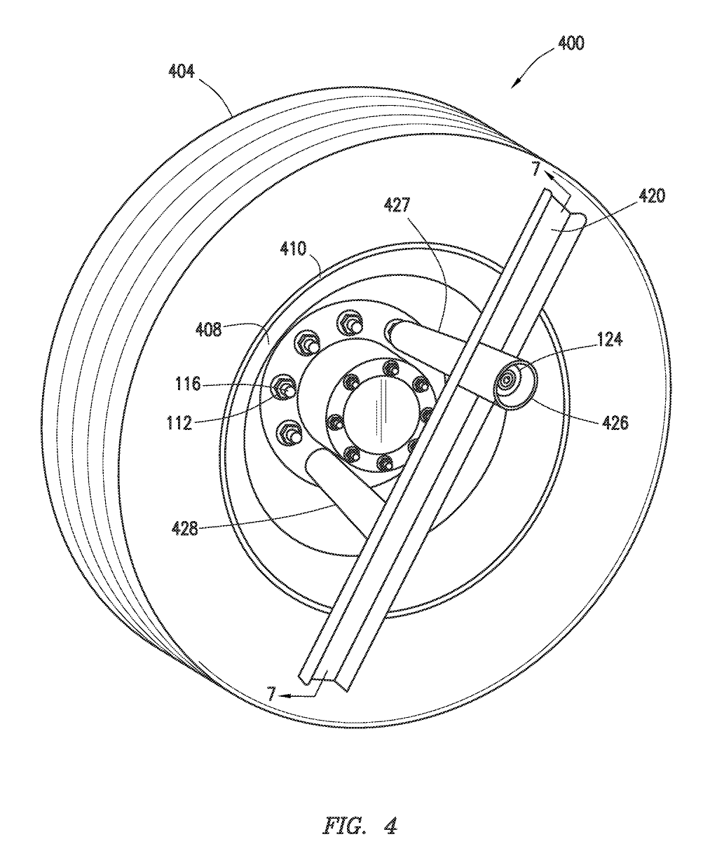

FIG. 4 shows a perspective view of an example rear truck wheel (e.g., a dual wheel) and tire assembly 400 in accordance with at least some embodiments. Tire 404 is mounted on wheel 408 which is coupled to the axle of a vehicle (not pictured) by a set of lug nuts 112 configured to fit on lug bolts 116. A theft prevention device 420 is mounted on the wheel 408 and extends across the wheel from one side of the tire's rim 410 to another side and further extends across portions of the tire 404 on two sides of the rim. The theft prevention device 420 is locked to the wheel by a locking device 124 coupled to one of the lug bolts 116 by a lug extension (not visible in FIG. 4). The lug extension serves as a first point of contact for the theft prevention device 420 and holds the theft prevention device 420 away from the tire 404. The lock 124 is surrounded by a protective collar 426 which guards the lock against unauthorized removal (e.g., by rotation of the locking device without a key or key socket). The theft prevention device 420 may also comprise a first riser 427 to serve as a protective housing for a lug extension. In some embodiments the first riser 427 is comprised of a section of cylindrical pipe. The theft prevention device 420 is also coupled to the wheel at a second point by a second riser 428 which contacts the wheel 408 at a second location. In the embodiment depicted in FIG. 4, the second riser 428 rests against the wheel 408 in an area adjacent to and surrounding one of the lug nuts 112. In some embodiments, the riser is comprised of a section of cylindrical pipe sized to fit around the perimeter of a lug nut 112. The second riser 428 provides a second point of contact for the theft prevention device, holding the device away from the surface of the tire 404. Riser 428 and may also prevent rotation of the theft prevention device 420 relative to the wheel 408 thus keeping the theft prevention device 420 in position to prevent tire removal. The length of the theft prevention device 420 may be selected so that the theft prevention device extends far enough past the rim 410 of the wheel 408 that it becomes difficult to remove the tire from the wheel with the device 120 locked to the wheel, but short enough that the ends of the theft prevention device 420 will not contact the ground when the tire 404 is compressed during movement of the vehicle.

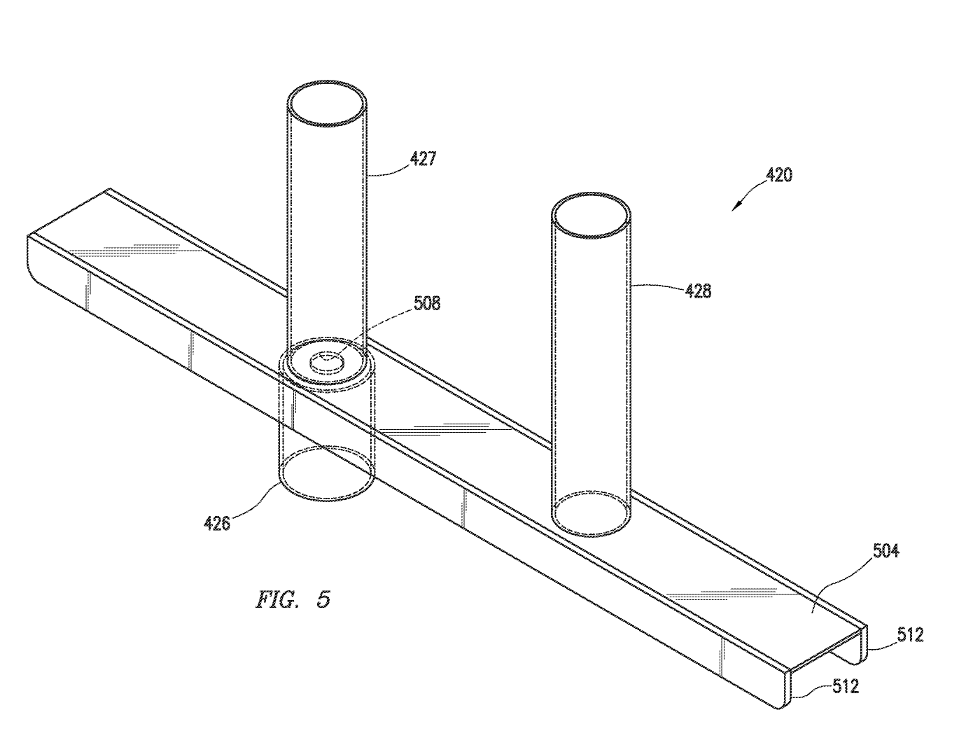

FIG. 5 shows a perspective view of the theft prevention device 420 of FIG. 4. In some embodiments the device may be comprised of an elongate strip of steel 504 extending the length of the device. In other embodiments the device may be comprised of another structural material (e.g., channel iron). The strip 504 may be coupled to risers 427, 428. Riser 428 comprises a cylindrical pipe having a diameter selected to accommodate placement of the theft prevention device 420 with riser 428 resting against a wheel on the area surrounding one of the lug nuts 112. Riser 427 comprises a cylindrical pipe having a diameter selected to accommodate a lug extension. Strip 504 also comprises a cutout area 508 to accommodate a lug extension (not pictured) disposed through the cutout area and extending into the interior area defined by the collar 426. The theft prevention device 420 may also comprise stiffening ribs 512 coupled to the strip 504 to add rigidity to the theft prevention device 420, and to prevent flexing of the theft prevention device 420 along the theft prevention device's length. In embodiments where the device is comprised of channel iron rather than of a strip of steel, the sides of the channel iron may serve as integral ribs.

In some example embodiments, the strip 504 may be a 3% inch-wide strip of 10 gauge steel, and the stiffening ribs 512 may each be ¼ inch thick, 1% inch-wide ribs welded to the strip 504 and extending the entire length of the theft prevention device 420. Collar 426 may be a 2% inch Schedule 10 steel pipe 4 inches long. In some embodiments, the tire theft prevention device may be 32¼ inches in length. Riser 427 may be a 2-inch Schedule 10 pipe 9% inches in length and riser 428 may be a 2-inch Schedule 10 pipe 11 inches in length. In some embodiments, cutout area 508 may have a diameter of one inch. The centers of risers 427, 428 may be separated by a distance of 11 ¼ inches. The measurements above are given by way of example only. In various embodiments the dimensions and configuration may be altered depending on the particular application. For example, the dimensions of the theft prevention device may depend on various factors including: the bolt pattern of the wheel on which the device will be used; the diameters of lug bolts used to couple the wheel to the vehicle; the size of lug nuts for a particular wheel; the profile of the vehicle tire the device is to be used with; or on the particular locking device to be used with the device. Furthermore, the various components discussed above may take any of a multitude of forms depending on various factors. As one example, the theft prevention device may be constructed out of an I-beam, channel iron, or other structural beam rather than out of sheet steel as discussed above. The theft prevention device may also be constructed out of any suitable material in addition to those materials discussed above.

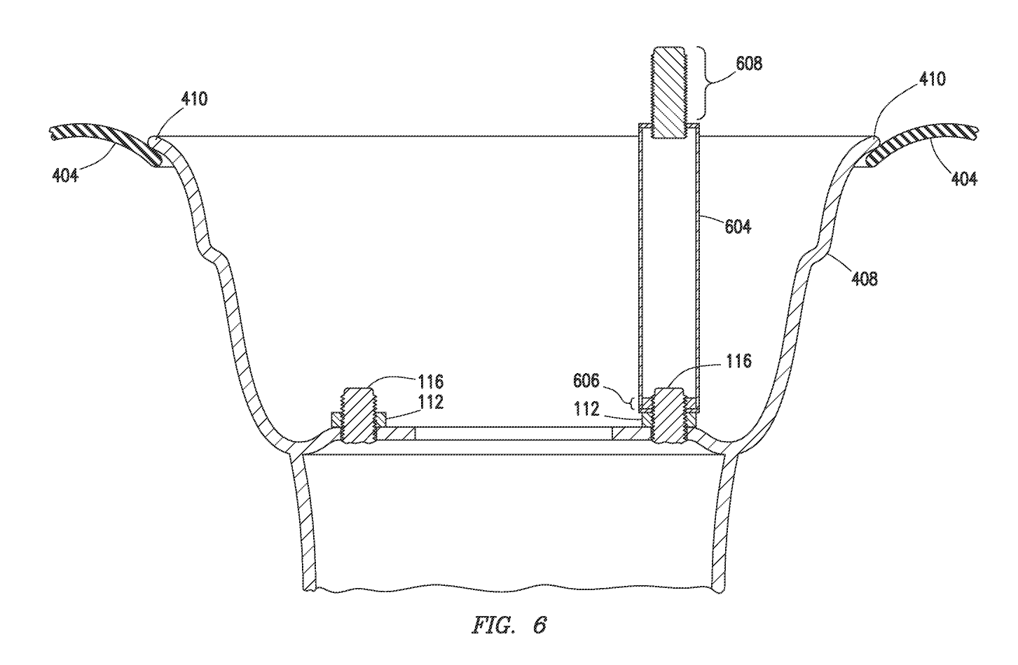

FIG. 6 is a cross-sectional view of the tire and wheel assembly of FIG. 4 taken along the line 7-7 of FIG. 4. In the cross-sectional view of FIG. 6, a lug extension 604 is coupled to one of the lug bolts 116. The lug extension allows for use of a locking device with the theft prevention device 420 of FIG. 4 designed to fit on “dually” truck wheels or on other wheels having lug bolts that are deeply recessed relative to the rim of the wheel. In some embodiments the lug extension 604 may be coupled to a lug bolt on top of a lug nut as is depicted in FIG. 6, while in other embodiments, one of the lug nuts may be removed prior to installation of the lug extension 604. In some embodiments, the lug extension 604 may have a threaded female portion 606 and threaded male portion 608 each having thread specifications matching that of the lug bolt 116.

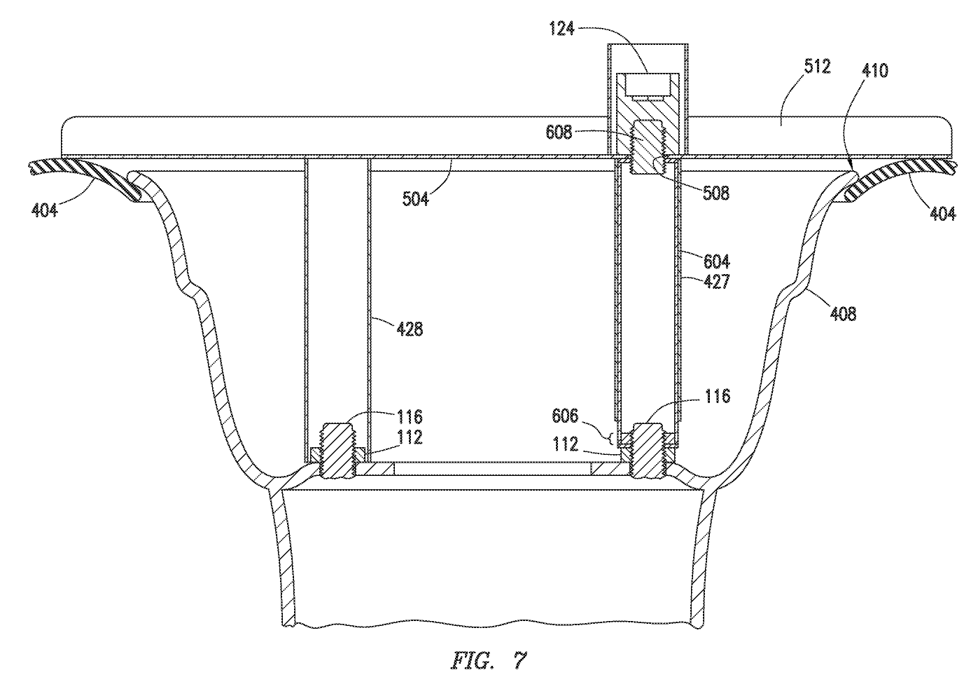

FIG. 7 is a cross-sectional view of theft prevention device 420 taken along the line 7-7 of FIG. 4. In the cross-sectional view of FIG. 7, the theft prevention device 420 is shown locked (via lug extension 604) to a wheel 408 with a mounted tire 404. The wheel 408 and tire 404 of FIG. 4 are also depicted in cross-section for purposes of illustration. As can be seen in the example embodiment of FIG. 7, the theft prevention device is coupled to the wheel by locking device 124 coupled to a lug extension 604. The locking device 124 is surrounded by collar 426 which protects the locking device 124 from being removed (e.g., by application of torque to the exterior diameter of the locking device) without a key or key socket. The theft prevention device is held away from the tire 404 by riser 428 and by lug extension 604. The riser 427 is coupled to the metal strip 504, and functions to protect the lug extension 604 from tampering (e.g., by cutting, hammering, or removal from the lug bolt 116 the lug extension 604 is coupled to). Metal strip 504 also comprises a cutout area 508 through which the male threaded portion 608 extends. Locking device 124 is coupled to the threaded male portion 608 of the lug extension 604 extending through cutout area 508. Riser 428 is configured to fit around a lug bolt 112. Riser 428 acts as a second point of support for the theft prevention device 120, and also prevents rotation of the theft prevention device 420 relative to the wheel 408. In some embodiments, stiffening ribs 512 may be configured to make the theft prevention device 520 inflexible about the theft prevention device's elongate axis so as to prevent riser 428 from being forced away from the wheel 108 and over the lug nut 112 and lug bolt 116 the riser 428 surrounds.

In the example embodiment of FIG. 7, even if tire 404 is deflated or even partially un-mounted from the wheel 408, the tire 404 cannot be completely be removed with the locking device 420 in place. Furthermore, compromise of the locking device 124 is made more difficult by the locking device 124 being surrounded by a collar 426. The collar 426, for example, protects the locking device from being removed by application of external torque, and also offers protection of the locking device against compromise by hammering, sawing, or cutting. Furthermore, if the length of the theft prevention device 420 is selected so as to not project beyond the diameter of the tire 404 when compressed by the weight of a vehicle, the theft prevention device 420 need not be removed from a wheel in order to move a vehicle, especially at low speeds.

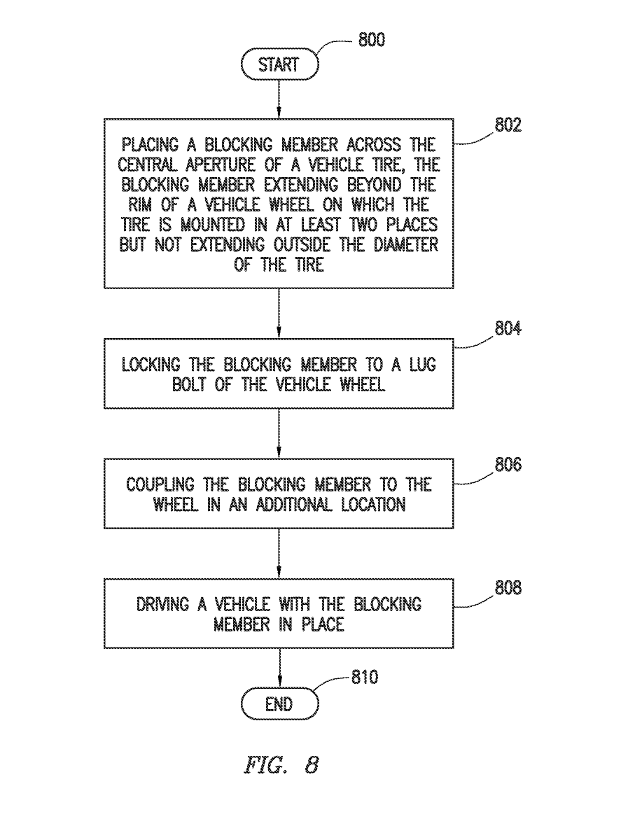

FIG. 8 shows a method in accordance with further embodiments. In particular, the method starts (block 800), and comprises: placing a blocking member across the central aperture of a vehicle tire, the blocking member extending beyond the rim of a vehicle wheel on which the tire is mounted in at least two places but not extending outside the diameter of the tire (block 802); locking the blocking member to a lug bolt of the vehicle wheel (block 804); and coupling the blocking member to the wheel in an additional location (block 806). In some embodiments the method may further comprise driving a vehicle with the blocking member in place (block 808). Thereafter, the method ends (block 810).

In some embodiments the method comprises coupling the blocking member to an additional location where the additional location comprises an area disposed around a second lug bolt. In other embodiments the method comprises placing the blocking member to prevent tire removal. In further embodiments the locking step further comprises coupling an extension member to the lug bolt. In some embodiments the locking member may be coupled to the extension member, while in other embodiments a locking member may be coupled to a lug bolt without using an extension member.

References to “one embodiment”, “an embodiment”, “a particular embodiment”, and “some embodiments” indicate that a particular element or characteristic is included in at least one embodiment of the invention. Although the phrases “in one embodiment”, “an embodiment”, “a particular embodiment”, and “some embodiments” may appear in various places, these do not necessarily refer to the same embodiment.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A tire removal prevention device comprising:
an elongate member having a first end and a second end, the first and second ends defining an elongate axis;
a collar member coupled to the elongate member, the collar defining an interior cavity, a first aperture, and a second aperture opposite the first aperture, the second aperture having an area smaller than the first aperture; and
a riser member coupled to the elongate member, the riser member defining a third aperture having an area larger than the second aperture.

2. The tire removal prevention device of claim 1, wherein the elongate member is inflexible along the elongate axis.

3. The tire removal prevention device of claim 1, wherein the elongate member comprises a metallic strip defining a first planar surface and a second planar surface facing opposite the first.

4. The tire removal prevention device of claim 3, wherein the elongate member further comprises a rib configured to reduce flexing of the elongate member along the elongate axis.

5. The tire removal prevention device of claim 4, wherein the elongate member further comprises a second rib configured to reduce flexing of the elongate member along the elongate axis.

6. The tire removal prevention device of claim 1, wherein the distance between the collar member and the riser member is less than the distance between the collar member and the first end.

7. The tire removal prevention device of claim 1, wherein the first and second apertures are circular and the first aperture has a diameter more than two times the diameter of the second aperture.

8. The tire removal prevention device of claim 7, wherein the third aperture is circular and has a diameter less than the first aperture.

9. The tire removal prevention device of claim 1, further comprising a locking member.

10. The tire removal prevention device of claim 9 wherein the locking member is configured to be coupled to a lug bolt disposed through the second aperture.

11. The tire removal prevention device of claim 1, further comprising an extension member configured to be coupled to a lug bolt.

12. The tire removal prevention device of claim 11, wherein the extension member is configured to be disposed through the second aperture.

13. The tire removal prevention device of claim 12, further comprising a locking member configured to couple to the extension member.

14. A method comprising:
placing a blocking member across a central aperture of a vehicle tire, the blocking member extending beyond a rim of a vehicle wheel on which the vehicle tire is mounted in at least two places but not extending outside the diameter of the vehicle tire;
locking the blocking member to a lug bolt of the vehicle wheel; and
coupling the blocking member to the vehicle wheel at an additional location.

15. The method of claim 14, wherein the additional location comprises an area disposed around a second lug bolt.

16. The method of claim 14, wherein the placing step further comprises placing the blocking member so as to prevent tire removal.

17. The method of claim 14, wherein the locking step further comprises coupling an extension member to the lug bolt.

18. The method of claim 17, wherein the locking step further comprises coupling a locking member to the extension member.

19. The method of claim 14, wherein the locking step further comprises coupling a locking member to the lug bolt.

20. The method of claim 14 further comprising driving a vehicle with the blocking member in place.

21. A tire removal prevention device comprising:
an elongate member comprising a metallic strip defining a first planar surface and a second planar surface facing opposite the first, the elongate member having a first end and a second end, the first and second ends defining an elongate axis;
a collar member coupled to the elongate member, the collar defining an interior cavity, a first aperture, and a second aperture opposite the first aperture, the second aperture having an area smaller than the first aperture;
a riser member coupled to the elongate member, the riser member defining a third aperture having an area larger than the second aperture.
a first rib coupled to the elongate member, the first rib configured to reduce flexing of the elongate member along the elongate axis;
a second rib coupled to the elongate member, the second rib configured to reduce flexing of the elongate member along the elongate axis; and
a locking member, the locking member configured to be coupled to a lug bolt, and to be disposed at least partially within the interior cavity defined by the collar member;
wherein the first, second, and third apertures are circular, the first aperture having a diameter more than two times the diameter of the second aperture, and the third aperture having a diameter less than the first aperture.
